(19) United States
(12) Patent Application Publication
(10) Pub. No.: US 2016/0207445 A1
(43) Pub. Date: Jul. 21, 2016

(54) HEADLIGHT ACTIVATION SYSTEM

(71) Applicant: Teressa Schou, Matawan, NJ (US)

(72) Inventor: Teressa Schou, Matawan, NJ (US)

(21) Appl. No.: 14/597,509

(22) Filed: Jan. 15, 2015

(51) Int. Cl. B60Q 1/04; B60S 1/08

(52) U.S. Cl. CPC B60Q 1/04; B60S 1/08; B60Q 2300/312

(57) ABSTRACT

A headlight activation system includes a vehicle that has headlights and windshield wipers. A control circuit is electrically coupled to the vehicle and the headlights. An actuator is electrically coupled to the windshield wipers and the control circuit. The control circuit actuates the headlights when the actuator is actuated to turn on the windshield wipers.

### BACKGROUND OF THE DISCLOSURE

1. Field of the Disclosure

The disclosure relates to headlight devices and more particularly pertains to a new headlight device for actuating a vehicle's headlights when the vehicle's windshield wipers are actuated.

2. Summary of the Disclosure

An embodiment of the disclosure meets the needs presented above by generally comprising a vehicle that has headlights and windshield wipers. A control circuit is electrically coupled to the vehicle and the headlights. An actuator is electrically coupled to the windshield wipers and the control circuit. The control circuit actuates the headlights when the actuator is actuated to turn on the windshield wipers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective in-use view of a headlight activation system according to an embodiment of the disclosure.

FIG. 2 is a back view of an embodiment of the disclosure.

FIG. 3 is a top view of an embodiment of the disclosure.

FIG. 4 is a front view of an embodiment of the disclosure.

FIG. 5 is a schematic view of an embodiment of the disclosure.

FIG. 6 is a logic tree view of an embodiment of the disclosure.

### DESCRIPTION OF THE PREFERRED EMBODIMENT

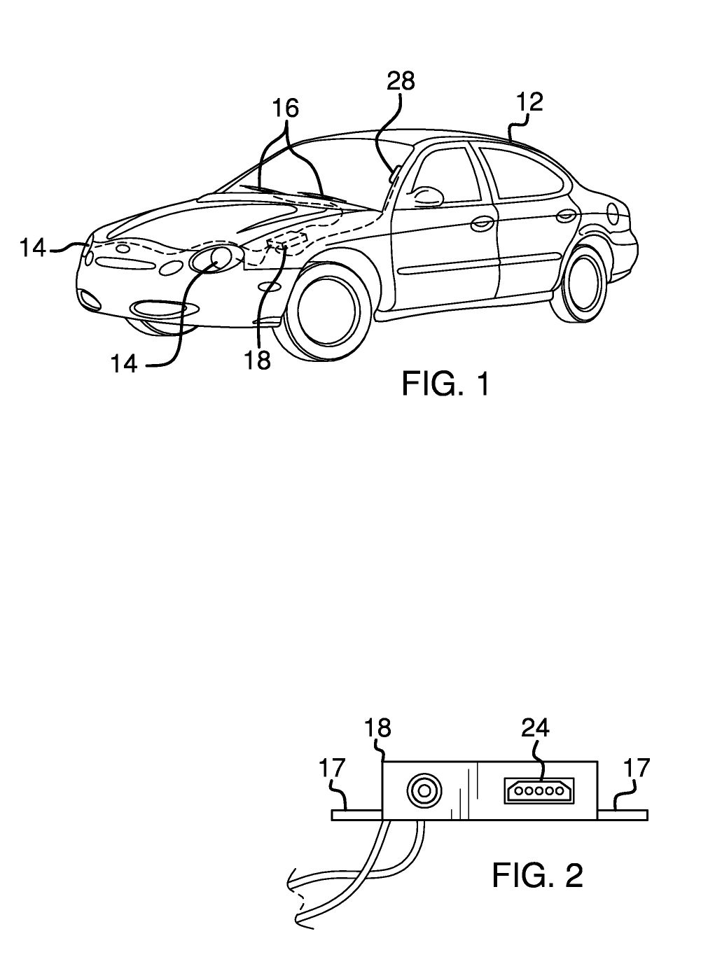

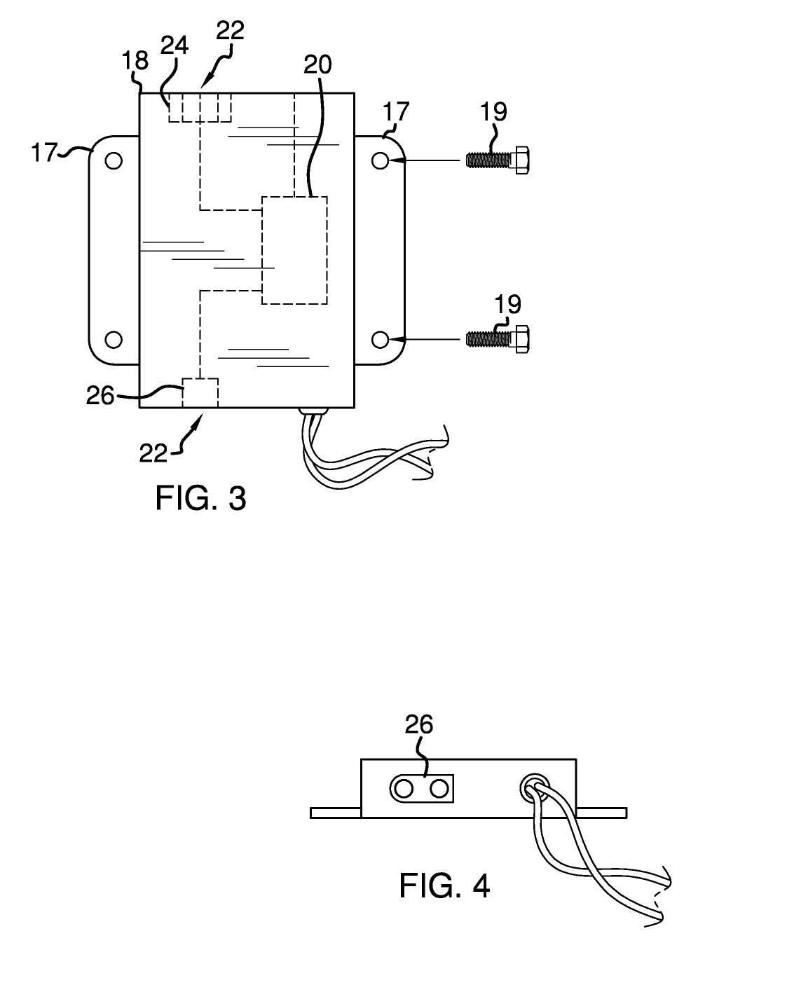

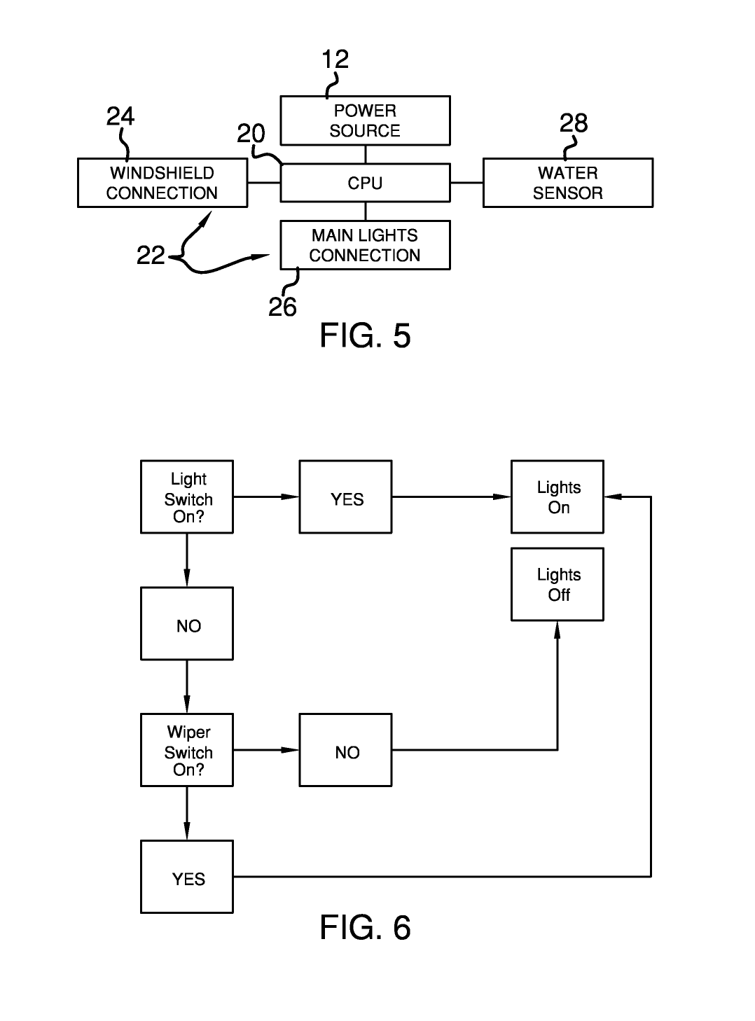

With reference now to the drawings, and in particular to FIGS. 1 through 6 thereof, a new headlight device embodying the principles and concepts of an embodiment of the disclosure and generally designated by the reference numeral 10 will be described.

As best illustrated in FIGS. 1 through 6, the headlight activation system 10 generally comprises a vehicle 12 that has headlights 14 and windshield wipers 16. The vehicle 12 may be a passenger vehicle or the like. Each of the headlights 14 and the windshield wipers 16 may be of any conventional design. A housing 18 may be provided that is coupled to the vehicle 12. A control circuit 20 is provided that is positioned within the housing 18 and the control circuit 20 is electrically coupled to the vehicle 12. A pair of tabs 17 are each coupled to the housing 18. A plurality of bolts 19 extends through each of the tabs 17 and engages the vehicle 12. The bolts 19 retain the housing 18 on the vehicle 12.

An actuator 22 is provided that is electrically coupled to the windshield wipers 16 and the control circuit 20. The control circuit 20 actuates the headlights 14 when the actuator 22 is actuated. The actuator 22 comprises a first port 24 that is coupled to the housing 18 and is electrically coupled to the control circuit 20. The first port 24 is electrically coupled to the windshield wipers 16 so the control circuit 20 is notified when the windshield wipers 16 are actuated.

A second port 26 is coupled to the housing 18 and the second port 26 is electrically coupled to the control circuit 20. The second port 26 is electrically coupled to the headlights 14 so the control circuit 20 actuates the headlights 14 when the windshield wipers 16 are actuated. A moisture sensor 28 is coupled to the vehicle 12 and the moisture sensor 28 is electrically coupled to the control circuit 20. The moisture sensor 28 senses precipitation and the control circuit 20 actuates the headlights 14 when the moisture sensor 28 senses precipitation. The motion sensor 28 may be a fluid sensor or the like. Additionally, the first 24 and second 26 ports may not be present if the control circuit 20 is hardwired into the headlights 14 and the windshield wipers 16.

In use, the system 10 ensures the headlights 14 are actuated each time the windshield wipers 16 are actuated. If the headlights 14 are actuated before the windshield wipers 16 are actuated, the headlights 14 will remain actuated after the windshield wipers 16 are de-actuated. If the headlights 14 are not actuated before the windshield wipers 16 are actuated, the headlights 14 are de-actuated when the windshield wipers 16 are de-actuated. The system 10 facilitates preventing the vehicle 12 from inadvertently violating traffic safety laws regarding the required used of headlights 14 when windshield wipers 16 are used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A headlight activation system configured to actuate headlights on a vehicle when the vehicle's windshield wipers are actuated, said system comprising:
a vehicle having headlights and windshield wipers;
a control circuit electrically coupled to said vehicle, said control circuit being electrically coupled to said headlights; and
an actuator electrically coupled to said windshield wipers, said actuator being electrically coupled to said control circuit, said control circuit actuating said headlights when said actuator is actuated to turn on said windshield wipers.

2. The assembly according to claim 1, further comprising a housing coupled to said vehicle, said control circuit being positioned within said housing.

3. The assembly according to claim 2, further comprising a first port coupled to said housing, said first port being electrically coupled to said control circuit, said first port being electrically coupled to said windshield wipers such that said control circuit is notified when said windshield wipers are actuated.

4. The assembly according to claim 3, further comprising a second port coupled to said housing, said second port being electrically coupled to said control circuit, said second port being electrically coupled to said headlights such that said control circuit actuates said headlights when said windshield wipers are actuated.

5. The assembly according to claim 4, further comprising a moisture sensor coupled to said vehicle, said moisture sensor being electrically coupled to said control circuit, said moisture sensor being configured to sense precipitation, said control circuit actuating said headlights when said moisture sensor senses precipitation.

6. A headlight activation system configured to actuate headlights on a vehicle when the vehicle's windshield wipers are actuated, said system comprising:
a vehicle having headlights and windshield wipers;
a housing coupled to said vehicle;
a control circuit positioned within said housing, said control circuit being electrically coupled to said vehicle;
an actuator electrically coupled to said windshield wipers, said actuator being electrically coupled to said control circuit, said control circuit actuating said headlights when said actuator is actuated to turn on said windshield wipers, said actuator comprising:
a first port coupled to said housing, said first port being electrically coupled to said control circuit, said first port being electrically coupled to said windshield wipers such that said control circuit is notified when said windshield wipers are actuated;
a second port coupled to said housing, said second port being electrically coupled to said control circuit, said second port being electrically coupled to said headlights such that said control circuit actuates said headlights when said windshield wipers are actuated; and
a moisture sensor coupled to said vehicle, said moisture sensor being electrically coupled to said control circuit, said moisture sensor being configured to sense precipitation, said control circuit actuating said headlights when said moisture sensor senses precipitation.
